(19) United States
(12) Patent Application Publication
(10) Pub. No.: US 2009/0253013 A1
(43) Pub. Date: Oct. 8, 2009

(54) ELECTRODE FOR FUEL CELL, MEMBRANE ELECTRODE ASSEMBLY AND FUEL CELL

(75) Inventor: Takenori ONISHI, Tenri-shi (JP)

Correspondence Address: NIXON & VANDERHYE, PC, 901 NORTH GLEBE ROAD, 11TH FLOOR, ARLINGTON, VA, 22203, US

(73) Assignee: SHARP KABUSHIKI KAISHA, Osaka (JP)

(21) Appl. No.: 12/018,304

(22) Filed: Jan. 23, 2008

(30) Foreign Application Priority Data
Jan. 24, 2007 (JP) 2007-013948

(51) Int. Cl. H01M 4/38; H01M 8/10

(52) U.S. Cl. 429/30; 429/44

(57) ABSTRACT

A fuel cell electrode includes a catalyst layer including an ion conductive substance, an electron conductive substance, and a catalytic activity substance. The catalytic activity substance includes Pt and at least one metal other than Pt. The catalyst layer includes at least two regions differing in the content ratio of Pt. A membrane electrode assembly and a fuel cell include the fuel cell electrode.

This nonprovisional application is based on Japanese Patent Application No. 2007-013948 filed with the Japan Patent Office on Jan. 24, 2007, the entire contents of which are hereby incorporated by reference.

### BACKGROUND OF THE INVENTION

1. Field of the Invention

The present invention relates to an electrode for a fuel cell, a membrane electrode assembly, and a fuel cell.

2. Description of the Background Art

In view of the spread of compact portable equipment and the increasing demand for an energy source for outdoor work and pleasure applications, there is a need for a portable power source that can be carried and used for a long period of time.

In this context, a liquid fuel cell employing liquid such as methanol or ethanol for fuel is attracting attention as an effective power source that has a high energy density and that can be used for a long period of time.

A polymer electrolyte membrane fuel cell (PEMFC) is known as one type of liquid fuel cell. A membrane electrode assembly (MEA) is used, having a fuel pole (anode) and an air pole (cathode) provided on one surface and the other surface, respectively, of a solid polyelectrolyte film.

FIG. 5 is a schematic sectional view of an example of a conventional membrane electrode assembly. A membrane electrode assembly 11 has a fuel pole 12 provided on one surface of a solid polyelectrolyte film 18 and an air pole 13 provided at the other surface of solid polyelectrolyte film 18. Fuel pole 12 is formed of a stack of a catalyst layer 14 and a diffusion layer 16. Air pole 13 is formed of a stack of a catalyst layer 15 and a diffusion layer 17.

At membrane electrode assembly 11 of such a configuration, the supply of liquid fuel such as methanol to fuel pole 12 and the supply of an oxidizing agent such as air to air pole 13 causes the travel of hydrogen ions (protons) generated at fuel pole 12 to air pole 13 via solid polyelectrolyte film 18 to produce water at air pole 13. Electrical energy is achieved by taking advantage of this electrochemical reaction.

The electrode reaction of the liquid fuel, when methanol is supplied to fuel pole 12 and oxygen is supplied to air pole 13, for example, is as follows:

(Fuel pole) CH₃OH+H₂O→CO₂+6H⁺+6e⁻

(Air pole) 3/2O₂+6H⁺+6e⁻→3H₂O

For the reaction at the fuel pole represented by the reaction formula set forth above, it is said that platinum (Pt) is the most effective catalytic activity substance with respect to the oxidation reaction of fuel. The reaction process thereof corresponds to the deprotonation of fuel by the catalytic action of Pt, resulting in the adsorption of CO to Pt after the deprotonation.

In the reaction at the fuel pole set forth above, the rate-determining step is based on desorption of CO from Pt (elimination of poisoning by CO). In order to alleviate poisoning by CO, a catalytic activity substance having higher tolerance to poisoning by CO is conveniently employed at the fuel pole.

For example, L. W. Niedrach et al. teaches on page 318 in “Electrocheni cal Technology”, Vol. 5, 1967 that the usage of a catalyst layer including binary metal of Pt and Ru (ruthenium) as the catalytic activity substance, instead of the generally-used single metal Pt, will alleviate the action of poisoning by CO at the typical operating temperature of a PEMFC.

The two tentative theories set forth below are proposed as the mechanism of alleviating poisoning by CO. The first theory is that the active site of the improved catalyst layer is less susceptible to the poisoning action by CO adsorption, so that more sites are left for a predetermined oxidation reaction. The second theory, is based on the notion that Ru acts as a promoter. Ru readily adsorbs the hydroxyl groups (OH group), and the OH groups adsorbed to Ru are effective for the desorption of CO from Pt, whereby CO poisoning is alleviated.

Although the mechanism of alleviating CO poisoning is not completely clarified yet, a catalyst layer including a catalytic activity substance formed of the binary metal of Pt and Ru is employed conveniently due to the favorable tolerance to CO poisoning at the fuel pole. Studies on the optimum content ratio of Pt and Ru to achieve the highest performance of a fuel cell are also conducted. The atomic composition ratio of 1:1 for the ratio of Pt and Ru has been presented (refer to Japanese Patent Laying-Open No. 63-097232).

### SUMMARY OF THE INVENTION

There is a demand for a liquid fuel cell more superior in output characteristics than the liquid fuel cell disclosed in the aforementioned Japanese Patent Laying-Open No. 63-097232.

In view of the foregoing, an object of the present invention is to provide an electrode for a fuel cell directed to improving the output characteristics of a liquid fuel cell, a membrane electrode assembly including that fuel cell electrode, and a fuel cell including that fuel cell electrode.

According to an aspect of the present invention, an electrode for a fuel cell includes a catalyst layer. The catalyst layer includes an ion conductive substance, an electron conductive substance, and a catalytic activity substance. The catalytic activity substance includes Pt and at least one metal other than Pt. The catalyst layer includes at least two regions differing in the content ratio of Pt.

As used herein, the “content ratio of Pt” in the present invention refers to the ratio of Pt atomicity to the total sum of the atomicity of Pt and the atomicity of metal other than Pt in the catalyst layer ((atomicity of Pt)/(total sum of atomicity of Pt+atomicity of metal other than Pt)).

In the fuel cell electrode of the present invention, Ru is preferably employed as the metal set forth above.

Furthermore, in the fuel cell electrode of the present invention, the catalytic activity substance is preferably an alloy of Pt and at least one metal other than Pt.

Furthermore, in the fuel cell electrode of the present invention, the catalyst layer includes a first catalyst layer and a second catalyst layer. The content ratio of Pt in the first catalyst layer is preferably different from the content ratio of Pt in the second catalyst layer.

In addition, the fuel cell electrode of the present invention is preferably used as a fuel pole to which liquid fuel is supplied. The fuel concentration of the liquid fuel is preferably at least 10 mol/l, and more preferably at least 15 mol/l. Methanol can be used as the fuel of the liquid fuel.

The present invention is also directed to a membrane electrode assembly having any of the fuel cell electrode set forth above formed on a surface of an electrolyte film.

In the membrane electrode assembly of the present invention, the content ratio of metal other than Pt at the surface of the catalyst layer located at the opposite side to the electrolyte film is preferably higher than the content ratio of metal other than Pt at the surface of the catalyst layer located at the electrolyte film side.

In the membrane electrode assembly of the present invention, the catalyst layer includes a first catalyst layer located at the opposite side to the electrolyte film, and a second catalyst layer located at the electrolyte film side. The content ratio of metal other than Pt in the first catalyst layer is preferably higher than the content ratio of metal other than Pt in the second catalyst layer.

As used herein, “the content ratio of metal other than Pt” in the present invention refers to the ratio of the atomicity of metal other than Pt with respect to the total sum of the atomicity of Pt and the atomicity of metal other than Pt in the catalyst layer ((atomicity of metal other than Pt)/(total sum of atomicity of Pt+atomicity of metal other than Pt)).

In addition, the present invention is directed to a fuel cell including any of the fuel cell electrode set forth above.

According to the present invention, an electrode for a fuel cell that can improve the output characteristics of the liquid fuel cell, a membrane electrode assembly including the fuel cell electrode, and a fuel cell including the fuel cell electrode can be provided.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic sectional view of an example of an electrode for a fuel cell according to the present invention.

FIG. 2 is a schematic sectional view of an example of a membrane electrode assembly of the present invention.

FIG. 3 represents the relationship of the methanol concentration (M) and current value (mA·mg⁻¹) when each electrode produced based on each of samples A-C is at 0.6 V.

FIG. 4 represents the relationship between the current density and voltage at each fuel cell of Example 1 and Comparative Example 1.

FIG. 5 is a schematic sectional view of an example of a conventional membrane electrode assembly.

### DESCRIPTION OF THE PREFERRED EMBODIMENTS

Embodiments of the present invention will be described hereinafter. In the drawings, the same reference characters represent the same or corresponding elements in the present invention.

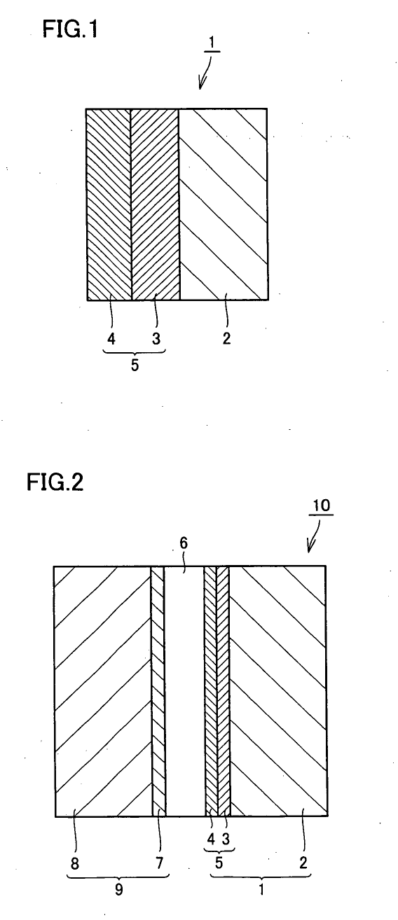

FIG. 1 is a schematic sectional view of an example of an electrode for a fuel cell according to the present invention. An electrode 1 for a fuel cell of the present invention includes a catalyst layer 5 having a first catalyst layer 3 and a second catalyst layer 4 stacked in this order on the surface of an electrode base 2.

Each of the first and second catalyst layers 3 and 4 includes an ion conductive substance, an electron conductive substance, and a catalytic activity substance. The catalytic activity substance includes Pt and at least one metal other than Pt.

The content ratio of Pt in first catalyst layer 3 differs from the content ratio of Pt in second catalyst layer 4. The content ratio of metal other than Pt in first catalyst layer 3 corresponding to the side of electrode base 2 is higher than the content ratio of metal other than Pt in second catalyst layer 4 corresponding to the electrolyte film side.

The inventor of the present invention confirmed that a liquid fuel cell having more favorable output characteristics can be achieved when fuel cell electrode 1 having a configuration set forth above was employed as a fuel pole. A likely reason for such an effect is set forth below.

Methanol that is employed as the liquid fuel generally takes the form of an aqueous solution, containing water in addition to methanol as the fuel contributing to electrode reaction. In the case where a catalytic activity substance of Pt and Ru, for example, is employed, it is considered that the step of rate-determining the reaction differs depending upon the methanol concentration in the liquid fuel.

In other words, when the methanol concentration in the liquid fuel is low, the amount of water in the liquid fuel is relatively large. Therefore, the presence of OH groups adsorbing to Ru is sufficient. It is considered that the oxidation reaction is rate-determined by the methanol concentration in the liquid fuel.

When the methanol concentration in the liquid fuel is high, the amount of methanol in the liquid fuel is relatively large. Therefore, the concentration of fuel in association with oxidation reaction is sufficient. However, the amount of OH groups adsorbing to Ru is relatively reduced. Thus, it is considered that the oxidation reaction is rate-determined by the amount of adsorption of the OH groups to Ru.

In view of the rate-determined step of the oxidation reaction depending upon the methanol concentration in the fuel liquid, the inventor considers that a catalyst layer formed having at least two regions differing in the Pt content ratio exhibits higher output characteristics than a catalyst layer formed containing Pt uniformly.

In the case where the fuel cell electrode of the present invention is employed as a fuel pole, the fuel concentration distribution is increased as the fuel concentration of the supplied liquid fuel is higher, preferable from the standpoint of readily achieving difference from a catalyst layer formed containing Pt uniformly. Although the fuel cell electrode of the present invention is convenient for usage as a fuel pole, the fuel cell electrode may also be used as an air pole.

The fuel concentration distribution will be described hereinafter. Liquid fuel is generally supplied from the part of electrode base 2 qualified as a diffusion layer. The liquid fuel flowing to catalyst layer 5 is partially consumed on the surface of the catalytic activity substance in catalyst layer 5 while permeating into the electrolyte film side by diffusion. On comparison between second catalyst layer 4 corresponding to the electrolyte film side and first catalyst layer 3 corresponding to the electrode base 2 side, the fuel concentration is lower at second catalyst layer 4 corresponding to the electrolyte film side than. at first catalyst layer 3 corresponding to the electrode base 2 side. A region having a different fuel concentration will be generated in catalyst layer 5. Thus, there will be a fuel concentration distribution in catalyst layer 5.

It is appreciated that there is a fuel concentration distribution in catalyst layer 5 of the fuel electrode from another standpoint. As indicated in the aforementioned reaction formula, water is generated by the reaction at the electrode base side of the catalyst layer of the air pole when oxygen is supplied to the air pole. Although the generated water will partially vaporize to be discharged to the atmosphere, at least a portion of the remaining water will diffuse to the electrolyte film side to permeate into the catalyst layer of the fuel pole. Diffusion of a substance generally occurs from a high concentration region towards a low concentration region. In view of the catalyst layer of the fuel pole that loses water by the reaction and the catalyst layer of the air pole that generates water by the reaction, it is considered that a portion of the water generated at the catalyst layer of the air pole diffuses to catalyst layer 5 of the fuel pole. Accordingly, the fuel concentration at second catalyst layer 4 of the fuel pole located at the electrolyte film side is reduced, leading to the generation of a fuel concentration distribution.

Thus, the supply of methanol aqueous solution as the liquid fuel to the fuel pole in the case where fuel cell electrode 1 of the present invention of the configuration shown in FIG. 1 is used as the fuel pole and Pt and Ru are used as the catalytic activity substance in catalyst layer 5 (first catalyst layer 3 and second catalyst layer 4) causes a fuel concentration distribution in which the methanol concentration of the supplied liquid fuel is lower at second catalyst layer 4 than at first catalyst layer 3.

By setting the content ratio of Pt low and the content ratio of Ru high at first catalyst layer 3 located at the second base 2 side where the methanol concentration is relatively high and the moisture concentration is relatively low in the liquid fuel, the OH groups from the relatively low amount of moisture supplied adsorbs to the large amount of Ru while oxidation reaction caused by the relatively large amount of methanol supplied is promoted by the presence of a low amount of Pt, leading to the development of electricity.

It is considered that the output characteristics of a liquid fuel cell is improved by the combination of the development of electrical energy and adsorption at second catalyst layer 4 located at the electrolyte film side and the development of electrical energy and adsorption at first catalyst layer 3 at the electrode base 2 side.

Namely, the oxidation reaction is rate-determined by the amount of adsorption of OH groups to Ru when the methanol concentration in the liquid fuel is high, and the oxidation reaction is rate-determined by the methanol concentration in the liquid fuel when the methanol concentration in the liquid fuel is low. In the present invention, by increasing the content ratio of Ru than Pt at first catalyst layer 3 located at the electrode base 2 side where the methanol concentration of the liquid fuel is relatively increased to cause adsorption of OH groups to a large amount of Ru, oxidation reaction can be facilitated. In addition, by increasing the content ratio of Pt than Ru at second catalyst layer 4 located at the electrolyte film side where the methanol concentration of the liquid fuel is relatively low to promote consumption of methanol, oxidation reaction can be facilitated.

By intentionally forming regions having the Pt content ratio altered according to the fuel concentration distribution developed at catalyst layer 5 in fuel cell electrode 1 of the present invention, the output characteristics of a liquid fuel cell can be improved.

Although the above description is based on an embodiment in which regions differing in Pt content ratio are provided in catalyst layer 5 by first catalyst layer 3 and second catalyst layer 4, the regions do not necessarily have to be present in the form of layers as long as catalyst layer 5 is formed having at least two sites where the Pt content ratio differs in the present invention.

In the present invention, a material including Pt and at least one metal other than Pt can be employed as the catalytic activity substance. Metal other than Pt constituting the catalytic activity substance includes, for example, Ru, Au (gold), Re (rhenium), Sn (tin), Rh (rhodium), Pd (palladium), Ir (iridium), Os (osmium), Ag (silver), nickel (Ni), cobalt (Co), or an alloy containing at least two of these metals. Particularly, a catalytic activity substance including Pt and Ru, or a catalytic activity substance including Pt and Sn, is preferable as the catalytic activity substance employed in the present invention. Furthermore, the catalytic activity substance preferably is an alloy of Pt and at least one metal other than Pt.

In the present invention, the grain size of the catalytic activity substance is preferably not more than 5 nm from the standpoint of increasing the surface area per unit mass and increasing the activity per unit mass of the catalytic activity substance. The grain size of the catalytic activity substance in the fuel cell electrode of the present invention can be estimated by actual measurements of an image obtained by means of a transmission electron microscope, or by using the Scherrer's equation on data obtained by X-ray diffraction analysis.

In the present invention, the content of the catalytic activity substance in catalyst layer 5 is preferably at least 10 mass parts and not more than 80 mass parts, more preferably at least 30 mass parts and not more than 80 mass parts, with respect to 100 mass parts of the electron conductive substance that will be described afterwards. In the case where the content of the catalytic activity substance is less than 10 mass parts with respect to 100 mass parts of the electron conductive substance, the amount of the catalytic activity substance is too low, leading to the tendency of not readily achieving the desired output characteristics. In the state of the art, it is difficult to increase the content of the catalytic activity substance higher than 80 mass parts with respect to 100 mass parts of the electron conductive substance. The content of the catalytic activity substance in catalyst layer 5 can be calculated from the change in mass before and after carrying the catalytic activity substance. It can also be calculated by identifying the input amount and the remaining amount after burning, based on the method of burning only the electron conductive substance using a thermo gravimetric analyzer.

As the ion conductive substance in the present invention, any ion conductive substance widely used in the field of fuel cell can be employed without particular limitation. In particular, a fluorine-based or hydrocarbon-based ion conductive substance is preferable. More preferably, a fluorine-based ion conductive substance is particularly used. Specifically, Nafion® by DuPont that is an ion-exchange resin of perfluorosulfonic acid polymer can be used conveniently.

Although the content of the ion conductive substance in catalyst layer 5 of the present invention is not particularly limited, the content is preferably at least 10 mass parts, more preferably at least 50 mass parts, with respect to 160 mass parts of the electron conductive substance that will be described afterwards. In the case where the content of the ion conductive substance with respect to 100 mass parts of the electron conductive substance is less than 10 mass parts, the formation rate at the three phase interface is low, leading to the tendency of the catalytic activity substance not being effectively used. The content of the ion conductive substance in catalyst layer 5 can be controlled by adjusting the input amount of the ion conductive substance at the time of mixing the electron conductive substance and the ion conductive substance. The content of the ion conductive substance can be readily calculated.

The electron conductive substance in the present invention is not particularly limited, and any electron conductive substance widely employed in the field of fuel cells can be employed. In view of the large surface area, carbon material is preferably used as the electron conductive substance. In addition, a semiconductor or metal particle having a surface area equal to or greater than that of carbon black can be used as the electron conductive substance.

In the present invention, the content of the electron conductive substance in catalyst layer 5 is not particularly limited. However, it is to be noted that if the content ratio of the electron conductive substance in the catalyst layer 5 is too low, there is a tendency of not being able to achieve sufficient output characteristics since the amount of the catalytic activity substance in the unit volume of catalyst layer 5 is reduced. In contrast, if the content ratio of the electron conductive substance is too high, the balance with the ion conductive substance in amount is poor, leading to the tendency of not being able to achieve sufficient output characteristics. The content of the electron conductive substance in catalyst layer 5 can be controlled by adjusting the input amount of the electron conductive substance during the mixture of the electron conductive substance and the ion conductive substance. The content of the electron conductive substance can be readily calculated.

The thickness of catalyst layer 5 in the present invention can be set to at least 20 μm and not more than 30 μm, for example, since it is necessary to include several mg/cm² catalytic activity substance in catalyst layer 5 to ensure sufficient development of electrical power. In the case where fuel that causes poisoning of the catalytic activity substance such as methanol is employed for the fuel of the liquid fuel, catalyst layer 5 may be formed thicker than in the general case for the purpose of compensating for the voltage loss caused by poisoning of the catalytic activity substance. In the case where catalyst layer 5 is formed thick, the voltage per unit cell of the liquid fuel cell can be increased.

Furthermore, forming a thick catalyst layer 5 is more preferable since the superiority of the configuration of the fuel cell electrode of the present invention will stand out due to the significance in the fuel concentration difference between the region located at the electrode base side and the region located at the electrolyte film side in catalyst layer 5.

In order to render the superiority of the configuration of fuel cell electrode 1 of the present invention more clear and further improve the output characteristics of a fuel cell employing fuel cell electrode 1 of the present invention, it is desirable to employ liquid fuel having the fuel concentration of preferably at least 10 mol/l (mol/liter), more preferably the high fuel concentration of at least 15 mol/l, as the liquid fuel supplied to fuel cell electrode 1. Methanol is preferably employed as the fuel in the liquid fuel.

FIG. 2 is a schematic sectional view of an example of a membrane electrode assembly of the present invention. In membrane electrode assembly 10, catalyst layer 5 has second catalyst layer 4 and first catalyst layer 3 sequentially stacked on one surface of electrolyte film 6. At the surface of catalyst layer 5, electrode base 2 functioning as the diffusion layer is formed. Catalyst layer 5 and electrode base 2 constitute fuel cell electrode 1 as the fuel pole. On the other surface of electrolyte film 6, catalyst layer 7 and electrode base 8 functioning as the diffusion layer are sequentially stacked, constituting air pole 9.

Membrane electrode assembly 10 shown in FIG. 2 can be produced as set forth below. An electron conductive substance carrying a catalytic activity substance, an ion conductive substance, and an organic solvent are mixed to produce the catalyst paste for forming first catalyst layer 3. In addition, an electron conductive substance carrying a catalytic activity substance, an ion conductive substance, and an organic solvent are mixed to produce the catalyst paste for forming second catalyst layer 4. The content ratio of Pt in the catalyst paste for formation of second catalyst layer 4 is set higher than the content ratio of Pt in the catalyst paste for formation of first catalyst layer 3.

The catalyst paste for formation of first catalyst layer 3 is applied on the surface of electrode base 2, and then the catalyst paste for formation of second catalyst layer 4 is applied on the surface of the catalyst paste for formation of first catalyst layer 3, followed by drying. Thus, first catalyst layer 3 and second catalyst layer 4 sequentially stacked on the surface of electrode base 2 are formed.

In continuation, the catalyst paste for formation of catalyst layer 7, prepared by mixing an electron conductive substance carrying a catalytic activity substance, an ion conductive substance, and an organic solvent, is applied on the surface of electrode base 8, followed by drying. Thus, catalyst layer 7 is formed on the surface of electrode base 8.

Then, the surface of second catalyst layer 4 located on the surface of electrode base 2 is brought into contact with one surface of electrolyte film 6, and the surface of catalyst layer 7 located on the surface of electrode base 8 is brought into contact with the other surface of electrolyte film 6, followed by thermocompression bonding. Accordingly, electrode base 2 and electrode base 8 are attached at respective faces of electrolyte film 6. Thus, membrane electrode assembly 10 is formed.

At membrane electrode assembly 10 produced as set forth above, catalyst layer 5 of fuel cell electrode 1 constituting the fuel pole is configured having a stack of first catalyst layer 3 located at the side opposite to electrolyte film 6 and second catalyst layer 4 located at the side of electrolyte film 6. The content ratio of metal other than Pt in first catalyst layer 3 is set higher than the content ratio of metal other than Pt in second catalyst layer 4. Therefore, the content ratio of metal other than Pt at the surface of catalyst layer 5 located at the opposite side to electrolyte film 6 is higher than the content ratio of metal other than Pt at the surface of catalyst layer 5 located at the side of electrolyte film 6.

When membrane electrode assembly 10 of the above-described configuration is employed for a liquid fuel cell, it is considered that the output characteristics of the liquid fuel cell is improved for the same reasons set forth above.

With regards to the method of applying the catalyst paste set forth above, the conventionally well-known screen printing, spraying, doctor blade method, roll coater method, or the like can be employed.

For the catalytic activity substance in catalyst layer 7 of air pole 9, Pt, Pt and Ru, Au, Re or Sn alloy, Rh, Pd, Ir, Os, Ru, Sn, Re, Au, Ag, Ni and Co, or an alloy including at least two of these metals can be employed. Particularly, Pt, an alloy of Pt and Ru, or an alloy of Pt and Sn, is preferably used as the catalytic activity substance in catalyst layer 7.

For electrolyte film 6, a proton conductive electrolyte film such as the well-known Nafion® can be used.

The present invention is also directed to a fuel cell including fuel cell electrode 1 of the above-described configuration. By including fuel cell electrode 1 of the above-described configuration in the fuel cell of the present invention, the usage rate of the catalytic activity substance is improved. A fuel cell superior in output characteristics can be achieved at low cost.

### EXAMPLE

### Samples A-C

Electron conductive substances carrying a catalytic activity substance set forth below were prepared (Samples A-C).

Sample A: TEC66E50 (Ketjen black carrying Pt-Ru alloy; Pt:32.6 mass %; Ru: 16.9 mass %; product of Tanaka Kikinzoku Kogyo K.K.)

Sample B: TEC61E54 (Ketjen black carrying Pt-Ru alloy; Pt: 30.1 mass %; Ru: 23.4 mass %; product of Tanaka Kikinzoku Kogyo K.K.)

Sample C: TEC62E58 (Ketjen black carrying Pt-Ru alloy; Pt: 27.9 mass %; Ru: 29.0 mass %; product of Tanaka Kikinzoku Kogyo K.K.)

### Production of Fuel Cell Electrode

First, 20 mg of Sample A, 9 mg of polyvinylidene fluoride resin, and 3 ml of N-methyl pyrrolidone were placed in the same screw tube vessel and mixed well for 30 minutes using an ultrasonic bath. 8 μl of the mixture was applied using a micro syringe on the surface of a 6 mm-diameter glassy carbon electrode, and dried for one complete day at 60° C. with a dryer to produce an electrode A. In addition, an electrode B (applied with mixture having Sample B mixed) and an electrode C (applied with mixture having Sample C mixed) were produced by a method similar to that of Sample A set forth above, provided that Samples B and C, respectively, were used instead.

### Evaluation of Fuel Cell Electrode

Evaluation of the electrodes were made using a rotating ring disk electrode measurement apparatus made by Nichiatsu Keisoku K. K. The evaluation was based on the three-electrode method, using 0.5 M of sulfuric acid for the electrolyte. For the fuel, 0.1 to 20 M of methanol aqueous solution was used. The catalytic activity of the electrode at respective concentration was evaluated. As used herein, “M” implies “mol/l”.

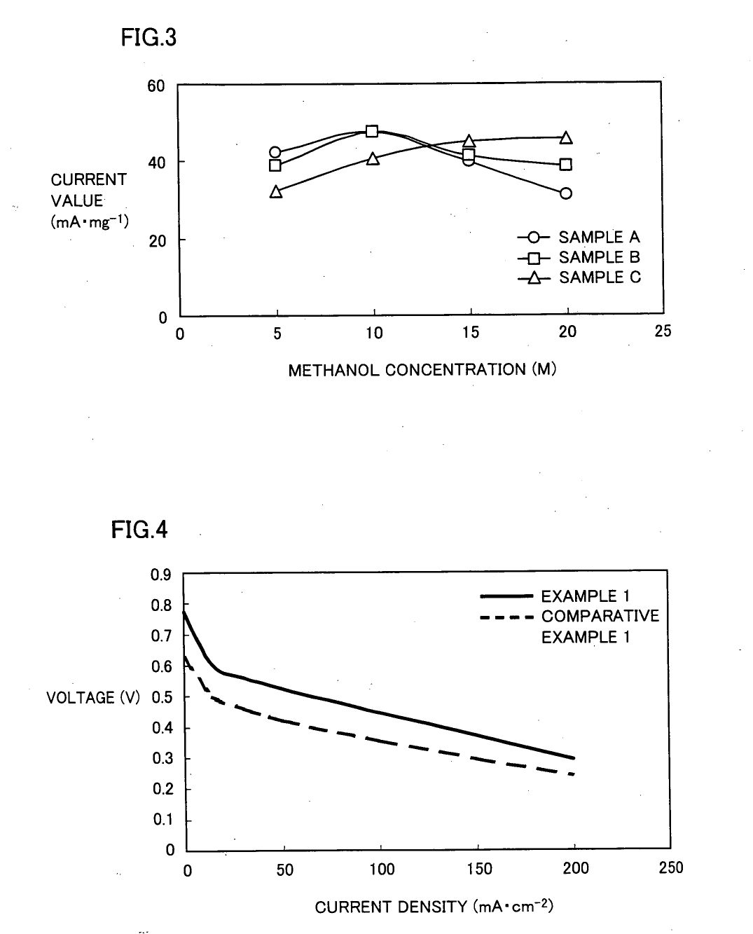

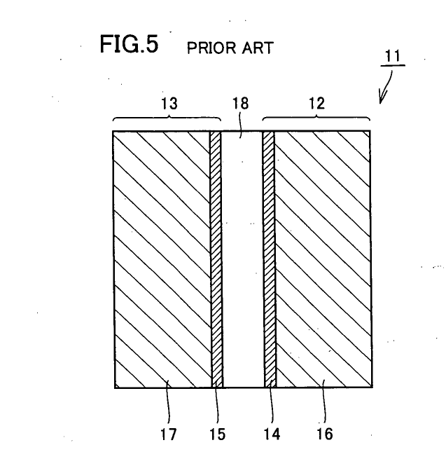

The evaluation was based on LSV (Linear Sweep Voltummetry) measurement, i.e. measuring the current value corresponding to potential sweep. FIG. 3 represents the relationship between the methanol concentration (M) and current value (mA·mg⁻¹) at 0.6V for each of electrodes produced as set forth above. In FIG. 3, Sample A, Sample B, and Sample C represent the evaluation results of electrode A, electrode B, and electrode C, respectively, set forth above.

### Example 1

An alcohol solution of Nafion® by DuPont (Nafion® content: 20 mass %; by Aldrich Co.) that is the ion-exchange resin of perfluorosulfonic acid polymer as the ion conductive substance, an inorganic solvent (pure water) and an organic solvent (isopropyl alcohol) for viscosity control were added to Sample A, and mixed well to take a paste form. Thus, the catalyst paste of Sample A was produced.

In a similar manner, the catalyst paste of Sample C was produced, provided that Sample C was used instead of Sample A set forth above.

To form the fuel pole, the catalyst paste of Sample C was applied uniformly by screen printing on the surface of carbon paper qualified as a 22.5 mm-square electrode base, and the catalyst paste of Sample A was applied uniformly on the catalyst paste of Sample C by screen printing, followed by drying for 15 minutes at 60° C. with a dryer. Thus, the fuel pole was produced.

The air pole was produced as set forth below. First, an alcohol solution of Nafion® by DuPont (Nafion® content: 20 mass %; by Aldrich Co.) that is the ion-exchange resin of perfluorosulfonate polymer as the ion conductive substance, an inorganic solvent (pure water) and an organic solvent (isopropyl alcohol) for viscosity control were added to TEC10E50 (Ketjen black carrying Pt; Pt:46.5 mass %; product of Tanaka Kikinzoku Kogyo K.K.), and mixed well to take a paste form. Thus, the catalyst paste for an air pole was produced.

The catalyst paste for an air pole produced as set forth above was applied uniformly by screen printing on the surface of a carbon paper qualified as a 22.5 mm-square electrode base, followed by drying for 15 minutes at 60° C. with a dryer to produce the air pole.

The fuel pole and air pole produced as set forth above were attached to a solid polyelectrolyte film identified as Nafion® 117 by DuPont such that the catalyst layer side of each pole was in contact with respective surfaces of the solid polyelectrolyte film by thermocompression bonding. Thus, a membrane electrode assembly (MEA) of Example 1 was produced.

### Comparative Example 1

A membrane electrode assembly (MEA) of Comparative Example 1 was produced in a manner similar to that of Example 1, except that a fuel pole was produced by applying the catalyst paste of Sample A uniformly on the surface of a carbon paper through screen printing, followed by drying for 15 minutes at 60° C. with a dryer. Namely, the catalyst layer at the fuel pole side in the membrane electrode assembly of Comparative Example 1 was produced from one type of catalyst paste. Therefore, the content ratio of Pt for the catalyst layer at the fuel pole side is constant.

### Evaluation Test

The membrane electrode assembly of Example 1 and the membrane electrode assembly of Comparative Example 1 produced as set forth above were individually placed in a fuel cell vessel (length 50 mm, width 100 mm, and height 100 mm) to produce a fuel cell of Example 1 with the membrane electrode assembly of Example 1 and a fuel cell of Comparative Example 1 with the membrane electrode assembly of Comparative Example 1.

Air and a methanol aqueous solution (methanol concentration: 10 M) were applied to the air pole and fuel pole, respectively, for each fuel cell of Example 1 and Comparative Example 1 to cause development of electrical power. The relationship between the current density and voltage for each fuel cell was evaluated. The results are shown in FIG. 4.

As shown in FIG. 4, it was confirmed that the fuel cell of Example 1 has improved output characteristics as compared to that of the fuel cell of Comparative Example 1. In FIG. 4, the solid line represents the relationship between the current density and voltage of the fuel cell of Example 1, whereas the broken line represents the relationship between the current density and voltage of the fuel cell of Comparative Example 1. In FIG. 4, the voltage (V) is plotted along the vertical axis and the current density (mA·cm²) is plotted along the horizontal axis.

The fuel cell has improved output characteristics in the case where the fuel cell electrode of the present invention is employed. Therefore, the fuel cell electrode of the present invention can be employed for the membrane electrode assembly of a fuel cell as well as for the fuel cell.

In particular, the present invention is conveniently applicable to a liquid fuel cell that produces electrical power by having liquid fuel such as a methanol aqueous solution supplied, and to a membrane electrode assembly employed in the formation of a liquid fuel cell.

Although the present invention has been described and illustrated in detail, it is clearly understood that the same is by way of illustration and example only and is not to be taken by way of limitation, the scope of the present invention being interpreted by the terms of the appended claims.

What is claimed is:

1. An electrode for a fuel cell, said electrode comprising a catalyst layer including an ion conductive substance, an electron conductive substance, and a catalytic activity substance,
said catalytic activity substance including platinum, and at least one metal other than platinum, and
said catalyst layer including at least two regions differing in a content ratio of platinum.

2. The electrode for a fuel cell according to claim 1, wherein said metal includes ruthenium.

3. The electrode for a fuel cell according to claim 1, wherein said catalytic activity substance includes an alloy of platinum and at least one metal other than platinum.

4. The electrode for a fuel cell according to claim 1, wherein said catalyst layer includes a first catalyst layer and a second catalyst layer, the content ratio of platinum in said first catalyst layer differs from the content ratio of platinum in said second catalyst layer.

5. The electrode for a fuel cell according to claim 1, wherein said electrode for a fuel cell is employed as a fuel pole to which liquid fuel is supplied.

6. The electrode for a fuel cell according to claim 5, wherein said liquid fuel has a fuel concentration of at least 10 mol/l.

7. The electrode for a fuel cell according to claim 6, wherein the fuel of said liquid fuel includes methanol.

8. The electrode for a fuel cell according to claim 5, wherein said liquid fuel has a fuel concentration of at least 15 mol/l.

9. The electrode for a fuel cell according to claim 8, wherein the fuel of said liquid fuel includes methanol.

10. A membrane electrode assembly, comprising the electrode for a fuel cell defined in claim 1 formed on a surface of an electrolyte film.

11. The membrane electrode assembly according to claim 10, wherein a content ratio of metal other than platinum at a surface of said catalyst layer located at an opposite side to said electrolyte film is higher than the content ratio of metal other than platinum at a surface of said catalyst layer located at a side of said electrolyte film.

12. The membrane electrode assembly according to claim 11, wherein said catalyst layer includes a first catalyst layer located at an opposite side to said electrolyte film, and a second catalyst layer located at a side of said electrolyte film, and the content ratio of metal other than platinum in said first catalyst layer is higher than the content ratio of metal other than platinum in said second catalyst layer.

13. A fuel cell, comprising the electrode for a fuel cell defined in claim 1.
